(19) United States
(12) Patent Application Publication
(10) Pub. No.: US 2013/0052392 A1
(43) Pub. Date: Feb. 28, 2013

(54) COMPOSITE COMPONENT FOR A VEHICLE

(71) Applicants: Karl Michael Radlmayr, Linz (AT); Konstantin Suhre, Lengerich (DE); Cornelis Gerardus Van Koert, Grootebroek (NL)

(72) Inventors: Karl Michael Radlmayr, Linz (AT); Konstantin Suhre, Lengerich (DE); Cornelis Gerardus Van Koert, Grootebroek (NL)

(73) Assignee: VOESTALPINE AUTOMOTIVE GMBH, Linz (AT)

(21) Appl. No.: 13/578,111

(22) PCT Filed: Dec. 29, 2010
(86) PCT No.: PCT/EP2010/070873

§ 371 Date: Nov. 9, 2012

(30) Foreign Application Priority Data
Feb. 9, 2010 (DE) 20 2010 002 099.9

(51) Int. Cl. B32B 3/18

(52) U.S. Cl. 428/68

(57) ABSTRACT

The invention relates to a composite component for a motor vehicle, in particular a structural component such as a longitudinal member, cross member, or A-, B-, or C-pillar, wherein the composite component comprises a structural component made of a press-hardened steel and wherein a plastic component is arranged at least in a subsection thereof in a form-fit inserted or molded-in manner in the structural component made of press-hardened steel at least in a subsection thereof, and wherein the plastic component is a component that is reinforced with steel wires and that is substantially made of a thermoplastic plastic and wherein a reinforcement structure such as a rib arrangement is injection molded into the plastic component.

### FIELD OF THE INVENTION

The invention relates to a composite component for a motor vehicle.

### BACKGROUND OF THE INVENTION

US 2008/0156425 A1 has disclosed a method for producing a component containing a plurality of preimpregnated fiber materials; an outermost pre-preg is placed onto a metallic component body; the pre-preg stack is shaped into a three-dimensional preform which is then pressed into the component body in a press mold. For example, the preforms are carbon-fiber-reinforced plastics intended for use as lightweight reinforcing elements in structural components.

DE 10 2008 032 344 A1 has disclosed an assembly, in particular a vehicle body. In order to produce a structural element particularly for this vehicle body which on the one hand, meets rigidity and strength requirements and on the other hand, does not require any new joining processes, but is nonetheless lightweight, in the proposed embodiment, the assembly is composed of a multi-part component made of carbon-fiber-reinforced plastic. In particular, it is a component composed exclusively of fiber-reinforced plastic.

EP 1 483 137 B1 has disclosed a reinforced impact beam; the impact beam is composed of a polymer matrix and a metallic reinforcing structure; the metallic reinforcing structure contains metal threads or metal cords arranged essentially parallel to one another and the polymer matrix has at least one first layer and one second layer; the first layer is situated around the metal cords and the second layer is situated around the first layer; some of the metal cords are to be laminated between two sheets of a polymer material that constitute the first layer of the polymer matrix in order to form a metal cord belt; and the metal cords are situated in one or more planes of the component.

U.S. Pat. No. 4,849,147 has disclosed a method for producing a hollow fiber-reinforced plastic structure with integrally molded fastening devices for attaching external components. The fastening device is attached to a piece of fibrous material into which plastic resin is injected. A finger holds the fastening device in place during the injection of the plastic resin.

US 2007/0277926 A1 has disclosed a device and method for forming a structural component for a motor vehicle and includes a hybrid structure that is preferably composed of two or more components that are bonded together with an adhesive to form a structural component that is lighter in weight than a traditional component composed of metal. The hybrid component should be essentially free of an over-molding process and should be provided with one or more snap-fits in order to hold the components to one another.

U.S. Pat. No. 5,888,600 has disclosed a reinforced structural component, which has a channel-shaped laminate structure, a metal stamped component, a channel-shaped formed plate element, and an intervening layer of structural foam. The component should be formed by pressing a plate-shaped plastic preform into the channel and thermally expanding the plastic resin to form a structural foam.

US 2008/0014388 A1 has disclosed a hollow chamber-like structural component, which includes a shell component that extends along a main extension direction; a cover component is attached to the shell component and between the two, a hollow chamber is formed and a reinforcing structure is arranged in the hollow chamber and comprises a synthetic support structure, which follows the main extension direction in at least some regions and rests with at least some regions against an inside of the shell component, and at least one reinforcing element that follows the main extension direction in at least some regions and is joined to the synthetic support structure with the aid of a layer of adhesive.

DE 10 2005 011 076 A1 has disclosed a method for producing vehicle door frames in which a door frame is assembled from a plurality of separate components; at least in one region of the interfaces between different components, these components are fastened to one another by means of an internal or external plastic injection molding process.

EP 1 342 623 A1 has disclosed a beam that is composed of a plastic matrix and a metallic reinforcing structure. The metallic reinforcing structure in this case is composed of metal cords that are preferably arranged parallel to one another in the plastic matrix in order to thus reinforce the latter.

The object of the invention is to create a composite component for motor vehicles, which accelerates the assembly of the motor vehicle and produces a highly stable component into which the necessary attachment regions and functional components are already integrated.

### SUMMARY OF THE INVENTION

According to the invention, a press-hardened structural component is produced, which is reinforced in at least some regions with a plastic component, thus producing a combined structural component. In this case, a preform is first produced from a fiber-reinforced plastic according to EP 1 483 137; this preform is embodied so that it can be inserted into the structural component in a form-locked fashion at the location provided.

After the press-hardening or mold-hardening is complete, while still warm in the region in which the plastic component is to be inserted, the structural component is coated—in particular sprayed—with a layer of adhesive, and then inserted into the plastic component. Since the plastic component is composed of a thermoplastic plastic, this ensures that the plastic component forms perfectly onto the structural component, particularly in connection with the applied adhesive; the residual temperature of the structural component, in particular from 150° C. to 350° C. ensures a very good bonding of the adhesive to the structural component on the one hand and to the thermoplastic plastic of the plastic component on the other.

In a first embodiment, a preform is produced from the plate-like steel-cord-reinforced plastic material according to EP 1 483 137, for example an approximately U-shaped preform, and then a transfer molding process is used to transfer mold a reinforcing structure, in particular a grid-like reinforcing structure, into the space enclosed by the preform. This grid-like reinforcing structure—which preferably ends along with the freely extending U legs of the preform—can be transfer molded together with connecting elements such as threads, threaded nuts, threaded bolts, and the like; if these elements are to protrude outward beyond the bottom wall of the preform, then corresponding openings are provided in the preform. In addition, however, belt reels for safety belts, and receiving compartments for air bags and the like can be injection molded or insert molded into the preform along with the grid structure.

The preform is then inserted into the structural component so that the side walls of its for example U-shape rest in a form-locked fashion against side walls of the structural component and are glued to the side walls of the structural component by means of an adhesive.

The grid structure, which is transfer molded in place for reinforcing purposes, is consequently enclosed on all sides by both the structural component and the preform.

In another advantageous embodiment, the plastic component or preform is inserted into the structural component, but the bottom wall of the preform rests on the bottom wall of the structural component and in this respect, the preform is inserted into the structural component in a form-locked fashion on all sides. The structural component is then transferred together with the plastic component into an injection mold and a plastic grid is additionally injection molded or transfer molded into the plastic formed component. Together with this grid pattern, additional functional components can be injection molded or insert molded into the plastic component, in particular threads, threaded nuts, threaded bolts, sockets, in particular movable sockets for belts, belt reels, anchor points for an interior trim panel or headliner, anchor points for air bag devices, and the like.

As a result, a composite component for a motor vehicle is produced, which is then incorporated into the motor vehicle using conventional joining techniques, in particular welding at the corresponding welding points, or other joining methods.

In another advantageous embodiment, the material comprising the plastic component, which is composed of the matrix of braided or twisted steel wire elements (cords)—which are held a definite distance apart from one another by means of fibers, in particular viscose fibers, and are for example laid crosswise—and of the thermoplastic plastic and possibly the internal glass fiber mats, is used as a flat, plate-like structure; the structural component, which is still warm from the PHS process, is inserted into a mold, the plate-like material according to EP 14 83 137 is placed onto the structural component at the desired location, and then with a tool—possibly even a preheated tool—is molded into the structural component. With this procedure as well, an adhesive layer can be produced on the structural component before the plate-like element is placed onto it.

The bonding of the component then takes place in the same way as in the first example.

The invention has the advantage that a press-hardened component, which inherently has a high rigidity and stability, is additionally reinforced with a plastic element in some regions; the plastic element itself is highly rigid and durable. It is also advantageous that a composite component with a high production depth can be built into a motor vehicle; the necessary attachment regions for screw connections, safety belts, airbags, and the like can also be injection molded into the region of the composite material ahead of time. The invention will be explained by way of example in conjunction with the drawings.

### BRIEF DESCRIPTION OF THE DRAWINGS

FIG. 1 is a very schematic depiction of the production sequence for the component according to the invention.

FIG. 2 is a side view of the component according to the invention, serving as a B-pillar.

FIG. 3 is a cross-section through the component according to FIG. 2.

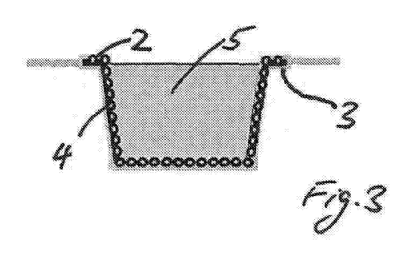

### DETAILED DESCRIPTION OF THE PREFERRED EMBODIMENTS

One starting point for the invention is press-hardened steel components, i.e. components in whose production a steel plate composed of a thermally hardenable steel is ready-formed in a cold forming process, then is heated, and then is cooled again in a special mold; the cooling takes place at a speed greater than the critical hardening speed, thus causing a hardening to occur, or a steel plate is hot formed and then in the hot-forming mold, is also hardened by being cooled at a speed greater than the critical hardening speed.

The finished component can in particular be a structural component of a motor vehicle that can also have more complex shapes. For example, the structural component can be a B-pillar of a motor vehicle.

Another starting point is a so-called EASI material according to EP 1 483 137, which was likewise developed by the applicant; this material is a plate-like material that includes a steel wire/viscous weave; this steel wire/viscous weave is composed of twisted or braided steel fibers (cords), in particular high-strength steel fibers, which can only stretch in one direction or can form a grid network; the steel wire fibers or the twisted or braided cords composed of a plurality of fibers are secured to one another by the viscose threads. In particular, the twisted or braided steel fiber cords can constitute warp threads and the viscose fibers can constitute weft threads or vice versa. Moreover, the steel fiber cords can also be correspondingly embedded in a knit or weave composed of viscose.

This steel wire/viscose weave is processed together with at least one glass fiber mat and an outer thermoplastic film as well as a thermoplastic resin flowing out of an extruder to form a plate-like material, which is correspondingly reinforced by the weave. In particular, the steel wire/viscose weave together with the thermoplastic resin can be placed between two glass fiber belts that are externally delimited by thermoplastic resin.

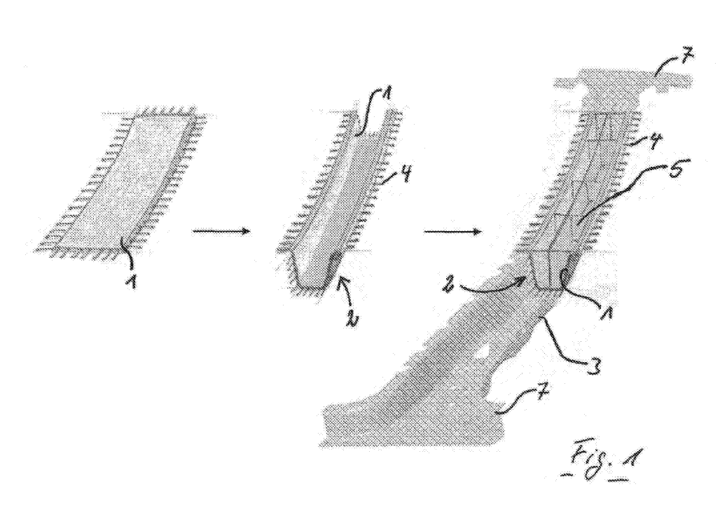

In a first embodiment of the method, this plate-like plastic material 1 (FIG. 1) is pressed into a preform 2 in a corresponding pressing mold, taking advantage of the thermoplastic properties of the plastic used. In another method step, a structural component 3 that is still warm is taken from the forming mold or cooling mold and placed into a region in which the bond between the preform 2 and the structural component 3 is to be produced, is coated with an adhesive (not shown), and then the preform 2 is inserted into the structural component 3 in a form-locked fashion. Steel threads 4 advantageously protrude from the outer edges of the preform 2 and are also in contact with the adhesive that has been applied and in particular, because of the braiding or twisting, have spread-open areas at the ends, which can cooperate with the adhesive particularly well because of their large surface area. It is also possible, however, for a soldering or welding to the PHS material to be carried out at the protruding ends.

After the insertion of the preform 2 into the structural component 3, the structural component 3 together with the preform 2 is transferred to another mold in which a transfer molding process is carried out. By means of the transfer molding process, a grid structure 5 is molded or injection molded into the preform 2 and then pressed, and due to the temperatures involved in the transfer molding assisted by the residual temperature of the structural component 3 and thus of the preform 2, this grid structure 5 bonds to the plastic material of the preform 2 and in particular, constitutes an integrated rib structure in the preform 2.

With the injection molding of the grid structure 5 into the preform 2, attaching elements (not shown) can also be insertion molded in a known way into the grid structure or together with the grid structure.

Such attaching elements include, for example, nuts, threads, threaded bolts, airbag mounting elements, airbag receiving elements, safety belt mounting elements, safety belt reels, and other conceivable elements that can or must be accommodated in structural components of motor vehicles such as A, B, or C-pillars as well as longitudinal beams and crossbeams.

Alternatively, the rib structure with the above-described mounting elements or functional components can first be transfer molded into the preform in order for the preform, with the grid structure oriented toward the structural component, to then be inserted into the structural component so that the rib structure is enclosed by the PHS material and the preform.

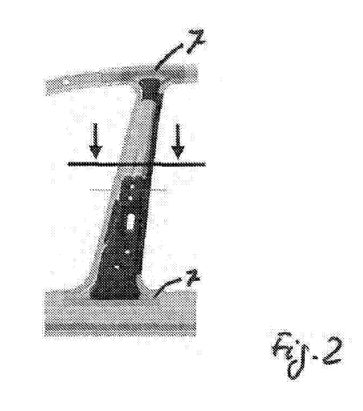

The completed composite component 6 (FIG. 2) has mounting regions 7 with which it can be mounted in a vehicle body.

In another advantageous embodiment, the method sequence is altered to the extent that instead of a preform 2, a plate-like EASI element 1 is placed onto the still warm structural component 3 in the region in which a plastic reinforcement is to be provided and then, by means of a suitable mold, is molded into the structural component in a form-locked fashion, possibly with the aid of additional heat.

The additional subsequent method steps correspond to the first embodiment, with the composite component corresponding to that of the first embodiment.

In this second advantageous embodiment as well, an adhesive layer is situated between the structural component and the EASI element.

The invention has the advantage of permitting inexpensive production of a composite component that is composed of a high-strength steel component, which is reinforced in some regions by a plastic, and, due to its special construction, demonstrates a ductile fracture behavior and good energy absorption behavior; additional mounting regions or mounting elements for additional components are already contained in the composite component, thus significantly facilitating the subsequent assembly of the motor vehicle.

In an embodiment with a rib structure enclosed by the structural component and the preform, it is advantageous that thanks to the distance of the steel cords from the structural component achieved by the embodiment, the tensile strength of the steel cords can optimally contribute to the strength of the composite component.

1. A composite component for a motor vehicle, comprising:
a structural component selected from the group consisting of a longitudinal beam, crossbeam, and A, B, or C-pillar, made of a press-hardened steel;
a plastic component inserted or molded into the structural component in a form-locked fashion in at least a portion of the structural component; wherein the plastic component is reinforced with steel wires and consists essentially of a thermoplastic plastic; and
a reinforcing structure injection molded into the plastic component.

2. The composite component as recited in claim 1, wherein the plastic component is glued into the structural component.

3. The composite component as recited in claim 1, further comprising mounting elements and functional components for mounting elements onto the structural component, wherein the mounting elements and functional components are injection molded or molded into the structural component along with the reinforcing structure.

4. The composite component as recited in claim 1, wherein protruding steel wire cords of the plastic component are glued, soldered, or welded to the structural component.
